(19) United States
(12) Patent Application Publication
(10) Pub. No.: US 2020/0067249 A1
(43) Pub. Date: Feb. 27, 2020

(54) Crimping Tool

(71) Applicant: Hanlong Industrial Co., Ltd., New Taipei City (TW)

(72) Inventors: Chien-Chou Liao, New Taipei City (TW); Chien-Wei Huang, New Taipei City (TW)

(21) Appl. No.: 16/244,373

(22) Filed: Jan. 10, 2019

(30) Foreign Application Priority Data
Aug. 24, 2018 (TW) 107129682

(51) Int. Cl. H01R 43/042; B25B 27/14

(52) U.S. Cl. CPC H01R 43/042; B25B 27/146

(57) ABSTRACT

A crimping tool is disclosed. The crimping tool comprises a first tool, a second tool, a crimping member, a first connecting rod and a second connecting rod. The first tool comprises a hole and a first shaft portion, wherein the first shaft portion is adjacent to a top end of the first tool. The second tool comprises a second shaft portion, wherein the first shaft portion and the second shaft portion are connected by a shaft member. The crimping member is disposed on the first tool. The first and the second connecting rods are respectively connected with the first tool, the second tool and the crimping member such that when the first tool and the second tool are rotated with respect to each other, the crimping member is pushed to move from a first position to a second position.

### BACKGROUND OF THE INVENTION

### Field of the Invention

The present invention relates to a crimping tool; more particularly, the present invention relates to a crimping tool for allowing the user to apply force more conveniently.

### Description of the Related Art

As technology develops, many different types of crimping tools have been developed to install joints or connector ports of different sizes. Please refer to FIG. 1A-1B, which illustrate an operation view of the crimping tool of the prior art. The crimping tool 90 of the prior art comprises a first tool 91, a second tool 92, a crimping member 93, a connecting rod 94, and a plurality of pivots 951, 952, and 953. The first tool 91 has a hole 911, and the crimping member 93 is adjacent to the hole 911. The first tool 91 is connected with one end of the connecting rod 94 by the pivot 951, another end of the connecting rod 94 is connected with the second tool 92 by the pivot 952, and the second tool 92 is connected with the crimping member 93 by the pivot 953. Thus, when the first tool 91 and the second tool 92 are pressed as shown in FIG. 1A and 1B, the crimping member 93 is moved by the connection of the first tool 91, the second tool 92, and the connecting rod 94. The joint or the connecting port to be installed can be placed in the hole 911 to be assembled by the crimping member 93.

However, a distance exists from the upper side of the pivot 953 of the crimping tool 90 to the top end of the first tool 91 in the prior art. Thus, the length of the arm is limited, which will cause the user to apply a larger force or increase the tool size. Therefore, it is necessary to invent a new crimping tool to mitigate and/or obviate the aforementioned problems.

### SUMMARY OF THE INVENTION

It is an object of the present invention to provide a crimping tool for allowing the user to apply force more conveniently.

To achieve the abovementioned object, a crimping tool comprises a first tool, a second tool, a crimping member, a first connecting rod, and a second connecting rod. The first tool comprises a hole, a first grip portion, and a first shaft portion, wherein the first shaft portion is adjacent to a top end of the first tool. The second tool comprises a second grip portion and a second shaft portion, wherein the first shaft portion and the second shaft portion are connected by a shaft member. The crimping member is disposed at the first tool and adjacent to the hole. The second connecting rod is connected with the first connecting rod, wherein the first connecting rod and the second connecting rod are connected with the first tool, the second tool, and the crimping member respectively; thus, when the first grip portion and the second grip portion are pressed, the first tool and the second tool are rotated with respect to each other to push the crimping member to move from a first position to a second position.

### BRIEF DESCRIPTION OF THE DRAWINGS

FIGS. 1A-1B illustrate an operation view of the crimping tool of the prior art.

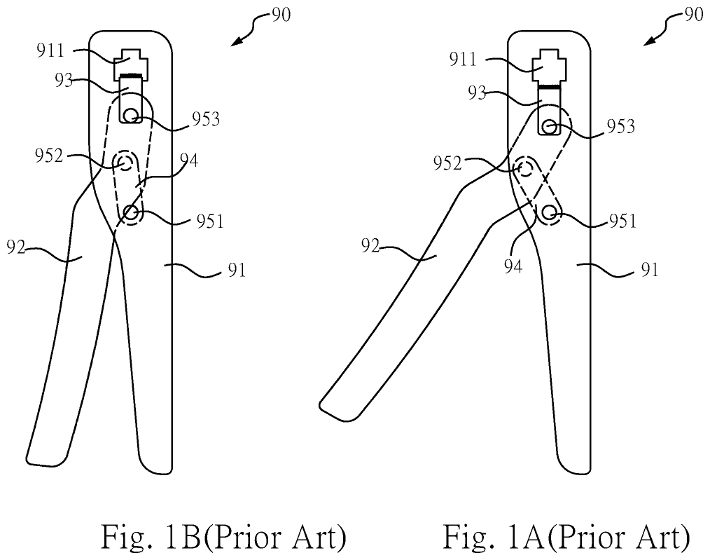

FIG. 2 illustrates a stereogram of a first embodiment of the crimping tool of the present invention.

FIG. 3 illustrates an exploded view of the first embodiment of the crimping tool of the present invention.

FIGS. 4A-4B illustrate an operation view of the first embodiment of the crimping tool of the present invention.

FIGS. 5A-5B illustrate an operation view of a second embodiment of the crimping tool of the present invention.

FIGS. 6A-6B illustrate an operation view of a third embodiment of the crimping tool of the present invention.

FIGS. 7A-7B illustrate an operation view of a fourth embodiment of the crimping tool of the present invention.

### DETAILED DESCRIPTION OF THE PREFERRED EMBODIMENT

The advantages and innovative features of the invention will become more apparent from the following detailed description when taken in conjunction with the accompanying drawings.

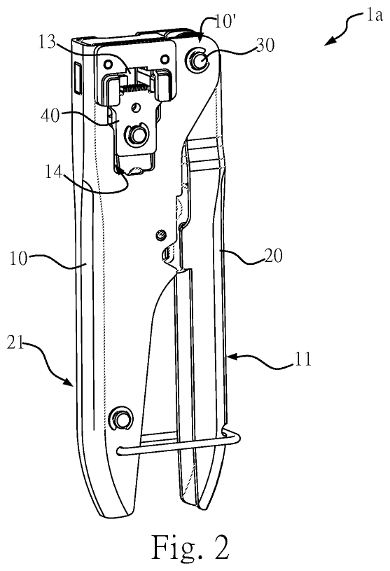

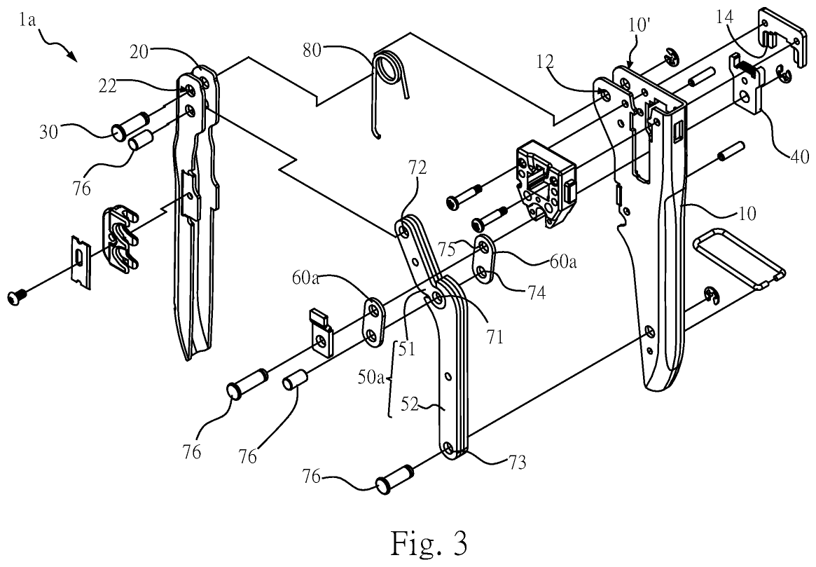

Hereafter, please first refer to FIG. 2, which illustrates a stereogram of the first embodiment of the crimping tool of the present invention, and FIG. 3, which illustrates an exploded view of the first embodiment of the crimping tool of the present invention. It should be noted that although the following description uses the terms “first”, “second”, etc., to describe various elements, these elements should not be limited by the terms. These terms are only used to distinguish one element from another. For example, a first tool may be referred to as a second tool and a second tool may be referred to as a first tool without departing from the scope of the various described embodiments. Each of the first tool and the tool module is a tool, but they are not the same tool.

In the first embodiment of the present invention, a crimping tool 1a comprises a first tool 10, a second tool 20, a crimping member 40a, a first connecting rod 50a, and a second connecting rod 60a. The first tool 10 comprises a first grip portion 11, a first shaft portion 12, and a hole 13. The second tool 20 comprises a second grip portion 21 and a second shaft portion 22, wherein the first shaft portion 12 and the second shaft portion 22 are connected by a shaft member 30 and adjacent to a top end 10′ of the first tool 10. Thus, when the first grip portion 11 and the second grip portion 21 are pressed, the first tool 10 and the second tool 20 are rotated with respect to each other by the shaft member 30.

The crimping member 40 is disposed at a sliding rail 14 of the first tool 10 and adjacent to the hole 13. The first connecting rod 50a is connected with the second connecting rod 60a and also connected with the first tool 10, the second tool 20, and the crimping member 40 respectively. Thus, when the first grip portion 11 and the second grip portion 21 are pressed, the first tool 10 and the second tool 20 are rotated with respect to each other by the shaft member 30 to push the crimping member 40 to move from a first position to a second position. Furthermore, an elastic element 80 is disposed between the first tool 10 and the second tool 20 to provide an elastic force after the first tool 10 and the second tool 20 are pressed. Therefore, when the first tool 10 and the second tool 20 are released, the first tool 10 and the second tool 20 will return to the original state and the crimping member 40 will return to the first position from the second position. The joint or the connecting port to be installed can be placed in the hole 13 to be assembled by the movement of the crimping member 40. The present invention does not limit the shape of the hole 13 and the crimping member 40.

Taking the exploded view shown in FIG. 3 as an example, the first connecting rod 50a of the crimping tool 1a comprises a first pivoting portion 71, a second pivoting portion 72, and a third pivoting portion 73; the second connecting rod 60a comprises a fourth pivoting portion 74 and a fifth pivoting portion 75. The second connecting rod 60a is made by two metal sheets so as to be disposed at the front and the back of the first connecting rod 50a, but the present invention is not limited thereto. Each of the pivoting portions is disposed on a pivot shaft 76, wherein the first pivoting portion 71 of the first connecting rod 50a is connected with the fourth pivoting portion 74 of the second connecting rod 60a by the same pivot shaft 76. In one embodiment of the present invention, the first connecting rod 50a comprises a first sub connecting rod 51 and a second sub connecting rod 52, wherein the second sub connecting rod 52 is pivotally connected with the first sub connecting rod 51 by a C-shaped connector. The first pivoting portion 71 and the second pivoting portion 72 are disposed at the first sub connecting rod 51; the third pivoting portion 73 is disposed at the second sub connecting rod 52. Thus, the first sub connecting rod 51 and the second sub connecting rod 52 are connected with each other and pivotally connected with the fourth pivoting portion 74 of the second connecting rod 60a.

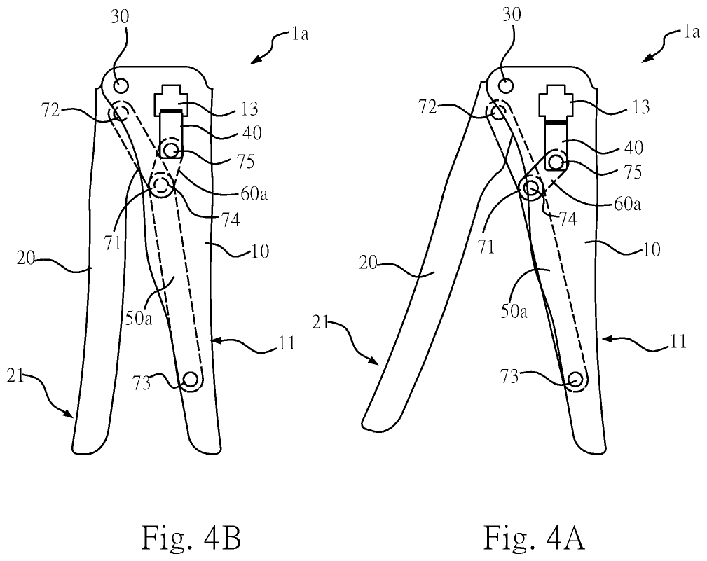

Please refer to FIGS. 4A-4B, which illustrate an operation view of the first embodiment of the crimping tool of the present invention.

The first connecting rod 50a is pivotally connected with the second tool 20 by the second pivoting portion 72. The first connecting rod 50a is pivotally connected with a portion adjacent to the first grip portion 11 on the first tool 10 by the third pivoting portion 73. The second connecting rod 60a is pivotally connected with the crimping member 40 by the fifth pivoting portion 75. The first pivoting portion 71 of the first connecting rod 50a is connected with the fourth pivoting portion 74 of the second connecting rod 60a by the same pivot shaft 76; thus, the first pivoting portion 71 and the fourth pivoting portion 74 are disposed at the same place. As a result, the first sub connecting rod 51 of the first connecting rod 50a can be rotated with respect to the second sub connecting rod 52, and the second connecting rod 60a can also be rotated with respect to the first connecting rod 50a. Therefore, when the first tool 10 and the second tool 20 are pressed to be rotated with respect to each other by the shaft member 30, the first sub connecting rod 51 and the second sub connecting rod 52 will be rotated at the same time; then the second connecting rod 60a will be rotated and pushed. Finally, the crimping member 40 will be moved from the first position to the second position by the pushing of the second connecting rod 60a.

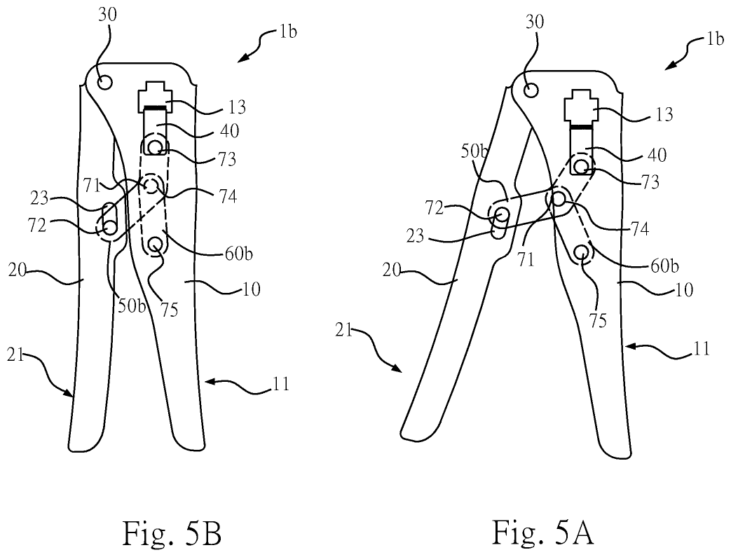

Please refer to FIGS. 5A-5B, which illustrate an operation view of the second embodiment of the crimping tool of the present invention.

In the second embodiment of the present invention, the first connecting rod 50b of the crimping tool 1b is V-shaped. The first connecting rod 50b is pivotally connected with a sliding hole 23 of the second tool 20 by the second pivoting portion 72, the first connecting rod 50b is pivotally connected with the crimping member 40 by the third pivoting portion 73, and the second connecting rod 60b is pivotally connected with the first tool 10 by the fifth pivoting portion 75. As a result, when the first tool 10 and the second tool 20 are pressed to be rotated with respect to each other by the shaft member 30, the second connecting rod 60b will also be rotated and the first connecting rod 50b will be rotated by the second connecting rod 60b. Finally, the crimping member 40 be pushed from the first position to the second position by the first connecting rod 50b.

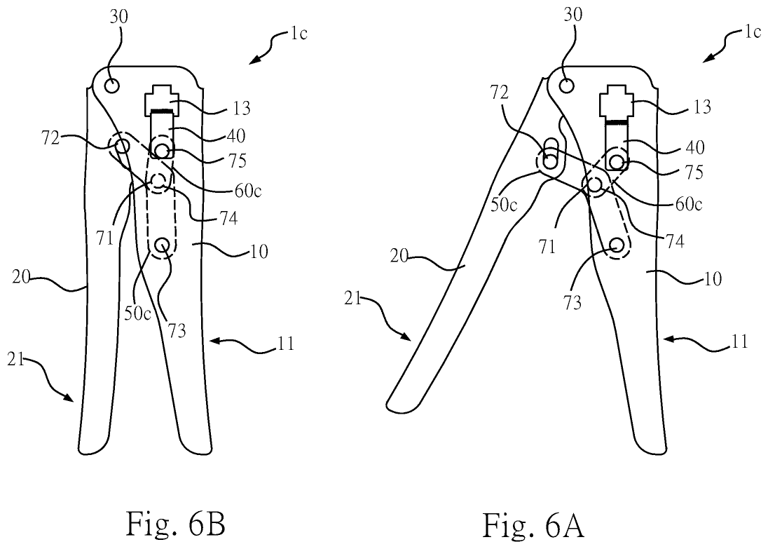

Please refer to FIGS. 6A-6B, which illustrate an operation view of the third embodiment of the crimping tool of the present invention.

In the third embodiment of the present invention, the first connecting rod 50c of the crimping tool 1c is pivotally connected with the second tool 20 by the second pivoting portion 72, the first connecting rod 50c is pivotally connected with the first tool 10 by the third pivoting portion 73, and the second connecting rod 60c is pivotally connected with the crimping member 40 by the fifth pivoting portion 75. The first pivoting portion 71 is disposed between the second pivoting portion 72 and the third pivoting portion 73. Thus, when the first tool 10 and the second tool 20 are pressed to be rotated with respect to each other by the shaft member 30, the first connecting rod 50c will be rotated, and the second connecting rod 60c will be rotated and moved at the same time by the first connecting rod 50c. Finally, the crimping member 40 will be pushed from the first position to the second position by the second connecting rod 60c.

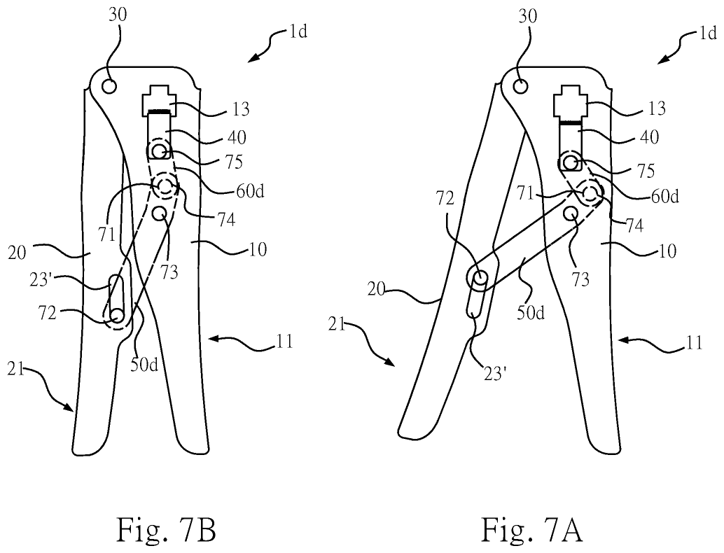

Please refer to FIGS. 7A-7B, which illustrate an operation view of the fourth embodiment of the crimping tool of the present invention.

In the fourth embodiment of the present invention, the first connecting rod 50d of the crimping tool 1d is pivotally connected with a sliding hole 23′ of the second tool 20 by the second pivoting portion 72, the first connecting rod 50d is pivotally connected with the first tool 10 by the third pivoting portion 73, and the second connecting rod 60d is pivotally connected with the crimping member 40 by the fifth pivoting portion 75. The third pivoting portion 73 is disposed between the first pivoting portion 71 and the second pivoting portion 72. As a result, when the first tool 10 and the second tool 20 are pressed to be rotated with respect to each other by the shaft member 30, the first connecting rod 50d will be rotated at the same time, and the second connecting rod 60d will be rotated and moved at the same time by the first connecting rod 50d. Finally, the crimping member 40 will be pushed from the first position to the second position by the connecting rod 60d.

In addition to the mechanical components described above, the crimping tools 1a, 1b, 1c, and 1d of the present invention may include other mechanical components. Since the technology of such other mechanical components is not the focus of the present invention, it will not be described here. Moreover, the present invention is not limited to the implementation of the above-mentioned crimping tools 1a, 1b, 1c, and 1d.

As described above, the crimping tools 1a, 1b, 1c, and 1d of the present invention can eliminate wasted space and allow the user to apply force more conveniently. Therefore, the problem of the prior art can be ameliorated.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A crimping tool, comprising:
a first tool comprising a hole, a first grip portion, and a first shaft portion,
wherein the first shaft portion is adjacent to a top end of the first tool;
a second tool comprising a second grip portion and a second shaft portion,
wherein the first shaft portion and the second shaft portion are connected by a shaft member;
a crimping member disposed at the first tool and adjacent to the hole;
a first connecting rod; and
a second connecting rod connected with the first connecting rod, wherein
the first connecting rod and the second connecting rod are connected with the first tool, the second tool, and the crimping member respectively; thus,
when the first grip portion aid the second grip portion are pressed, the first tool and the second tool are rotated with respect to each other to push the crimping member to move from a first position to a second position.

2. The crimping tool as claimed in claim 1, wherein the first connecting rod comprises a first pivoting portion, a second pivoting portion, and a third pivoting portion, and the second connecting rod comprises a fourth pivoting portion and a fifth pivoting portion, wherein each of the pivoting portions is disposed on a pivot shaft such that the first pivoting portion of the first connecting rod is connected with the fourth pivoting portion of the second connecting rod by the same pivot shaft.

3. The crimping tool as claimed in claim 2, wherein the first connecting rod comprises a first sub connecting rod and a second sub connecting rod;
the first sub connecting rod and the second sub connecting rod are pivotally connected with each other and pivotally connected with the fourth pivoting portion of the second connecting rod.

4. The crimping tool as claimed in claim 3, wherein the first connecting rod is pivotally connected with the second tool by the second pivoting portion, the first connecting rod is pivotally connected with the first tool by the third pivoting portion, and the second connecting rod is pivotally connected with the crimping member by the fifth pivoting portion, such that when the first tool and the second tool are pressed and rotated with respect to each other by the shaft member, the second connecting rod pushes the crimping member to move from the first position to the second position.

5. The crimping tool as claimed in claim 4, wherein the first pivoting portion is disposed between the second pivoting portion and the third pivoting portion.

6. The crimping tool as claimed in claim 4, wherein the third pivoting portion is disposed between the first pivoting portion and the second pivoting portion.

7. The crimping tool as claimed in claim 2, wherein the first connecting rod is pivotally connected with the second tool by the second pivoting portion, the first connecting rod is pivotally connected with the first tool by the third pivoting portion, and the second connecting rod is pivotally connected with the crimping member by the fifth pivoting portion, such that when the first tool and the second tool are pressed and rotated with respect to each other by the shaft member, the second connecting rod pushes the crimping member to move from the first position to the second position.

8. The crimping tool as claimed in claim 7, wherein the first pivoting portion is disposed between the second pivoting portion and the third pivoting portion.

9. The crimping tool as claimed in claim 7, wherein the third pivoting portion is disposed between the first pivoting portion and the second pivoting portion.

10. The crimping tool as claimed in claim 2, wherein the first connecting rod is pivotally connected with the second tool by the second pivoting portion, the first connecting rod is pivotally connected with the crimping member by the third pivoting portion, and the second connecting rod is pivotally connected with the first tool by the fifth pivoting portion, such that when the first tool and the second tool are pressed and rotated with respect to each other by the shaft member, the first connecting rod pushes the crimping member to move from the first position to the second position.

11. The crimping tool as claimed in claim 2, wherein the second tool further comprises a sliding hole for allowing the second pivoting portion of the first connecting rod to slide within the sliding hole.

12. The crimping tool as claimed in claim 1, wherein the first tool comprises a sliding rail to allow the crimping member to move.

13. The crimping tool as claimed in claim 1, wherein the first connecting rod is V-shaped.

14. The crimping tool as claimed in claim 1, wherein an elastic element is further disposed between the first tool and the second tool to provide an elastic force after the first tool and the second tool are pressed.
